(19) United States
(12) Patent Application Publication
(10) Pub. No.: US 2016/0380439 A1
(43) Pub. Date: Dec. 29, 2016

(54) NOTIFICATION TECHNIQUES FOR WIRELESS POWER TRANSFER SYSTEMS

(71) Applicants: Lei SHAO, Sunnyvale, CA (US); Xintian E. LIN, Mountain View, CA (US)

(72) Inventors: Lei SHAO, Sunnyvale, CA (US); Xintian E. LIN, Mountain View, CA (US)

(21) Appl. No.: 14/752,775

(22) Filed: Jun. 26, 2015

(51) Int. Cl. H02J 5/00; H02J 50/60; H02J 50/12

(52) U.S. Cl. CPC H02J 5/005; H02J 50/12; H02J 50/60

(57) ABSTRACT

Notification techniques for wireless power transfer systems are described. In one embodiment, for example, an apparatus may comprise a power transmitting unit (PTU) and logic, at least a portion of which is in hardware, the logic to initiate an extraneous object detection procedure to check for a presence of extraneous objects within a transfer field of the PTU during operation of the PTU in a power transfer state, and in response to a detection of an extraneous object, send an extraneous object notification message to a power receiving unit (PRU) and determine whether to maintain the PTU in the power transfer state based on a determination of whether the extraneous object comprises a rogue object. Other embodiments are described and claimed.

### TECHNICAL FIELD

Embodiments described herein generally relate to wireless power transfer systems.

### BACKGROUND

In a typical near-field wireless power transfer system, a power transmitting unit (PTU) is capable of wirelessly transferring power to compatible devices that are located within a transfer field of that PTU. In order to initiate wireless charging of a user device, a user may simply position that user device at a point located within the transfer field. In many systems, it may easy, and even common, for objects other than those to be charged to be inadvertently placed within the PTU transfer field. Some types of objects may have detrimental effects on the performance of the system if they are positioned within the transfer field. For example, various types of objects may interfere with the ability of the PTU to wirelessly transfer power to compatible devices within the transfer field, and may even have the potential of posing a safety hazard.

### BRIEF DESCRIPTION OF THE DRAWINGS

FIG. 1 illustrates an embodiment of a first operating environment.

FIG. 2 illustrates an embodiment of a second operating environment.

FIG. 3 illustrates an embodiment of a third operating environment.

FIG. 4 illustrates an embodiment of a first logic flow.

FIG. 5 illustrates an embodiment of a second logic flow.

FIG. 6 illustrates an embodiment of a third logic flow.

FIG. 7A illustrates an embodiment of a first storage medium.

FIG. 7B illustrates an embodiment of a second storage medium.

FIG. 8 illustrates an embodiment of a device.

FIG. 9 illustrates an embodiment of a wireless network.

### DETAILED DESCRIPTION

Various embodiments may be generally directed to notification techniques for wireless power transfer systems. In one embodiment, for example, an apparatus may comprise a power transmitting unit (PTU) and logic, at least a portion of which is in hardware, the logic to initiate an extraneous object detection procedure to check for a presence of extraneous objects within a transfer field of the PTU during operation of the PTU in a power transfer state, and in response to a detection of an extraneous object, send an extraneous object notification message to a power receiving unit (PRU) and determine whether to maintain the PTU in the power transfer state based on a determination of whether the extraneous object comprises a rogue object. Other embodiments are described and claimed.

Various embodiments may comprise one or more elements. An element may comprise any structure arranged to perform certain operations. Each element may be implemented as hardware, software, or any combination thereof, as desired for a given set of design parameters or performance constraints. Although an embodiment may be described with a limited number of elements in a certain topology by way of example, the embodiment may include more or less elements in alternate topologies as desired for a given implementation. It is worthy to note that any reference to “one embodiment” or “an embodiment” means that a particular feature, structure, or characteristic described in connection with the embodiment is included in at least one embodiment. The appearances of the phrases “in one embodiment,” “in some embodiments,” and “in various embodiments” in various places in the specification are not necessarily all referring to the same embodiment.

Embodiments herein are generally directed to wireless power transfer systems. Various embodiments may involve wireless power transfers performed according to one or more wireless power transfer standards. Wireless power transfer technologies and/or standards that may be used in some embodiments may include, for example, Rezence standards promulgated by the Alliance for Wireless Power, Qi standards promulgated by the Wireless Power Consortium, and the Power 2.0 standard promulgated by the Power Matters Alliance. The embodiments are not limited to these examples.

Various embodiments may involve wireless communications performed according to one or more wireless communications standards. For example, some embodiments may involve wireless communications in Bluetooth Low Energy (also known as Bluetooth Smart) wireless networks according to Bluetooth Core Specification 4.2, released December 2014, and/or any predecessors, progeny, and/or variants thereof. Additional examples of wireless communications technologies and/or standards that may be used in various embodiments may include—without limitation—IEEE wireless communication standards such as the IEEE 802.11, IEEE 802.11a, IEEE 802.11b, IEEE 802.11g, IEEE 802.11n, IEEE 802.11u, IEEE 802.11ac, IEEE 802.11ad, IEEE 802.11af, and/or IEEE 802.11ah standards, High-Efficiency Wi-Fi standards developed by the IEEE 802.11 High Efficiency WLAN (HEW) Study Group, Wi-Fi Alliance (WFA) wireless communication standards such as Wi-Fi, Wi-Fi Direct, Wi-Fi Direct Services, Wireless Gigabit (“WiGig”), WiGig Display Extension (WDE), WiGig Bus Extension (WBE), WiGig Serial Extension (WSE) standards and/or standards developed by the WFA Neighbor Awareness Networking (NAN) Task Group. Some embodiments may involve wireless communications performed according to one or more next-generation 60 GHz (“NG60”) wireless local area network (WLAN) communications standards and/or one or more millimeter-wave (mmWave) wireless communication standards.

Various embodiments may involve wireless communications performed according to one or more broadband wireless communications standards. For example, some embodiments may involve wireless communications performed according to one or more 3rd Generation Partnership Project (3GPP), 3GPP Long Term Evolution (LTE), and/or 3GPP LTE-Advanced (LTE-A) technologies and/or standards, including their predecessors, revisions, progeny, and/or variants. Additional examples of broadband wireless communication technologies/standards that may be utilized in various embodiments may include—without limitation—Global System for Mobile Communications (GSM)/Enhanced Data Rates for GSM Evolution (EDGE), Universal Mobile Telecommunications System (UMTS)/High Speed Packet Access (HSPA), and/or GSM with General Packet Radio Service (GPRS) system (GSM/GPRS), IEEE 802.16 wireless broadband standards such as IEEE 802.16m and/or IEEE 802.16p, International Mobile Telecommunications Advanced (IMT-ADV), Worldwide Interoperability for Microwave Access (WiMAX) and/or WiMAX II, Code Division Multiple Access (CDMA) 2000 (e.g., CDMA2000 1×RTT, CDMA2000 EV-DO, CDMA EV-DV, and so forth), High Performance Radio Metropolitan Area Network (HIPERMAN), Wireless Broadband (WiBro), High Speed Downlink Packet Access (HSDPA), High Speed Orthogonal Frequency-Division Multiplexing (OFDM) Packet Access (HSOPA), High-Speed Uplink Packet Access (HSUPA) technologies and/or standards, including their predecessors, revisions, progeny, and/or variants. Further examples of wireless communications technologies and/or standards that may be used in some embodiments may include—without limitation—machine-type communications (MTC) standards such as those embodied in 3GPP Technical Report (TR) 23.887, 3GPP Technical Specification (TS) 22.368, and/or 3GPP TS 23.682, and/or near-field communication (NFC) standards such as standards developed by the NFC Forum, including any predecessors, revisions, progeny, and/or variants of any of the above.

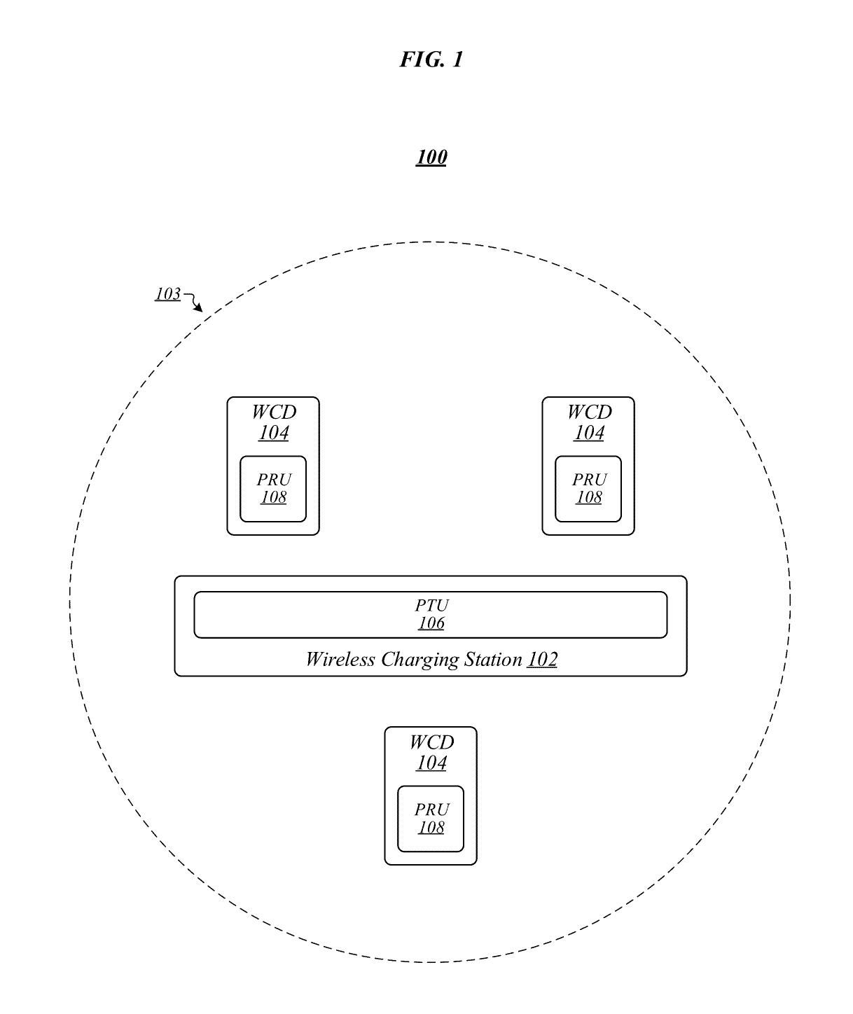

FIG. 1 illustrates an example of an operating environment 100 that may be representative of various embodiments. In operating environment 100, a wireless charging station 102 is configured with the ability to wirelessly transfer power to capable devices within a transfer region 103. It is worthy that the size and shape of transfer region 103—as well as its position and orientation relative to wireless charging station 102—may vary from embodiment to embodiment, and are not limited to the example depicted in FIG. 1. In this example, wireless charging station 102 provides power to a plurality of wirelessly-chargeable devices (WCDs) 104 that are located within transfer region 103. Wireless charging station 102 comprises a power transmitting unit (PTU) 106, which it uses to transfer power to a respective power receiving unit (PRU) 108 at each of the plurality of WCDs 104. In some embodiments, PTU 106 may transfer power to PRUs 108 via resonant inductive coupling. The embodiments are not limited in this context.

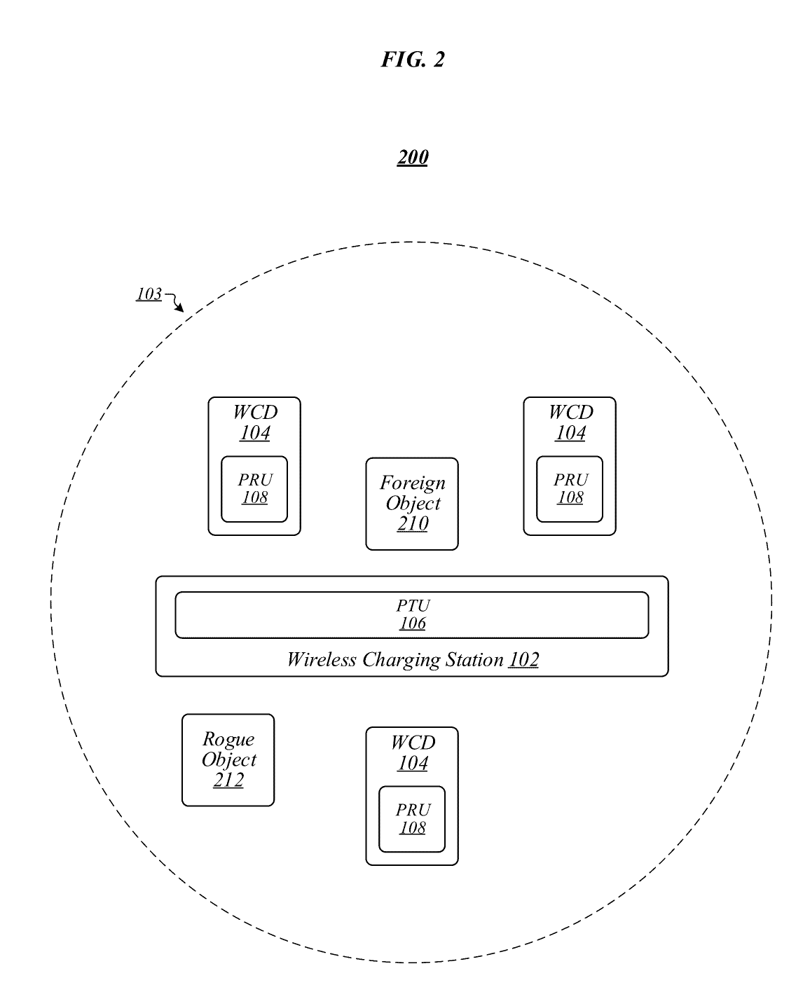

FIG. 2 illustrates an example of an operating environment 200 that may be representative of various embodiments. In operating environment 200, in addition to the plurality of WCDs 104 of operating environment 100 of FIG. 1, a foreign object 210 and a rogue object 212 are located within the transfer region 103 of wireless charging station 102. Foreign object 210 may generally comprise any object that—by virtue of its presence within transfer region 103—reduces the efficiency with which wireless charging station 102 is able to wirelessly transfer power to the WCDs 104 within transfer region 103. Examples of foreign object 210 in some embodiments may include—without limitation—a coin and a key. Rogue object 212 may generally comprise any object that—by virtue of its present within transfer region 103—poses a safety hazard and/or poses a threat of causing damage to PTU 106 and/or wireless charging station 102. In a non-limiting example embodiment, rogue object 212 may comprise a digital video disk (DVD) that may potentially become very hot and pose a fire hazard if left in close proximity to wireless charging station 102. Hereinafter, the term “extraneous object” shall be employed as an umbrella term to encompass both foreign objects and rogue objects. According to this definition, a given extraneous object may be a foreign object such as foreign object 210 or may be a rogue object such as rogue object 212. The embodiments are not limited in this context.

In view of the undesirable effects that may potentially be associated with the presence of extraneous objects within transfer region 103, wireless charging station 102 may be configured to check for the presence of extraneous objects within transfer region 103 using an extraneous object detection procedure. In various embodiments, wireless charging station 102 may be configured to repeat the extraneous object detection procedure periodically, at a rate selected in order to ensure that extraneous objects that may enter transfer region 103 are detected relatively quickly. In some embodiments, the extraneous object detection procedure may enable wireless charging station 102 both to check for the presence of extraneous objects and to determine whether any such objects are rogue objects. In various embodiments, upon detecting the presence of extraneous object(s), wireless charging station 102 may proceed in a manner determined based on whether any rogue objects are present. In some embodiments, in response to determining that one or more rogue objects are present, wireless charging station 102 may transition PTU 106 from a power transfer state to a non-transfer state. In various such embodiments, the non-transfer state may comprise a latching fault state. On the other hand, in response to determining that one or more extraneous objects are present but that none comprise rogue objects, wireless charging station 102 may maintain PTU 106 in the power transfer state.

In operating environment 200, the presence of any extraneous objects within transfer region 103—and the actions taken by wireless charging station 102 following the detection thereof—may affect the ability of the various WCDs 104 to receive power from wireless charging station 102. If wireless charging station 102 transitions PTU 106 to the non-transfer state due to the presence of rogue object 212, then the various WCDs 104 will no longer receive power from PTU 106 at all. Even if rogue object 212 is not present, and thus wireless charging station 102 maintains PTU 106 in the power transfer state, the presence of foreign object 210 may reduce the efficiency with which the various WCDs 104 receive power from PTU 106. These effects have the potential to negatively impact the user experience with respect to user(s) of the various WCDs 104. For example, after having placed a WCD 104 within transfer region 103 to charge, a user may return at a later time to find that the WCD 104 has only partially charged—or has not charged at all—due to the presence of extraneous objects within transfer region 103. If knowledge of the presence of extraneous objects is confined to wireless charging station 102, then it may be common or even likely that the user's first received indication of the presence of extraneous object(s) in transfer region 103 comes in the form of his/her device's failure to properly/efficiently charge.

Disclosed herein are notification techniques for wireless power transfer systems that may be implemented in some embodiments in order to improve the user experience with respect to users of wirelessly-chargeable devices in wireless power transfer systems. According to various such techniques, in response to a detection of an extraneous object within the transfer field of a PTU, a notification may be sent to one or more PRUs located within that transfer field. In some embodiments, the notification may be sent using an in-band signaling mechanism. In various other embodiments, the notification may be sent using an out-of-band signaling mechanism rather than—or in addition to—via the in-band signaling mechanism. In some embodiments, in response to receipt of such a notification, a given PRU may in turn initiate a user alert procedure on a WCD in which that PRU is contained. In various such embodiments, according to the user alert procedure, an alert message, window, dialog, icon, sound, or other type of notification may be presented on/by the WCD, on/by another device associated with a same user as the WCD, or both. The embodiments are not limited in this context.

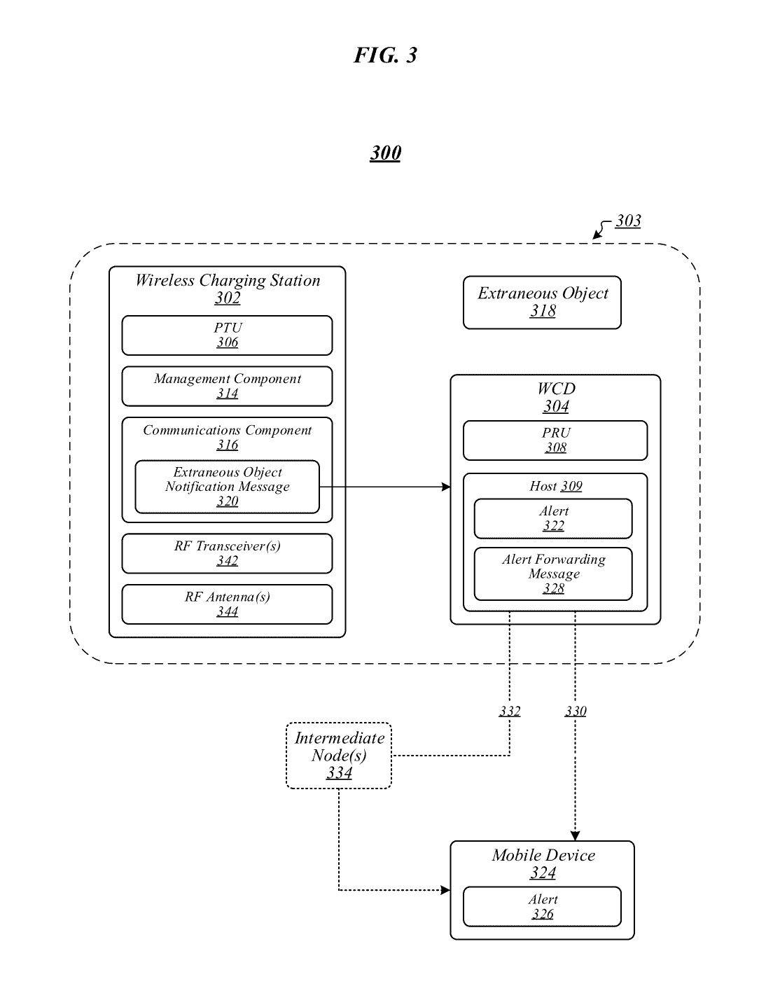

FIG. 3 illustrates an example of an operating environment 300 that may be representative of the implementation of the disclosed notification techniques for wireless power transfer systems in some embodiments. In operating environment 300, a wireless charging station 302 is capable of using a PTU 306 to provide power to WCDs within a transfer region 303. A WCD 304 located within transfer region 303 is capable of receiving power from wireless charging station 302 using a PRU 308. In various embodiments, wireless charging station 302, transfer region 303, and PTU 306 may be the same as—or similar to—wireless charging station 102, transfer region 103, and PTU 106, respectively, in FIGS. 1 and 2. In some embodiments, WCD 304 and PRU 308 may be the same as—or similar to—any particular WCD 104 and corresponding PRU 108, respectively, in FIGS. 1 and 2. In various embodiments, WCD 304 may comprise a mobile computing device, such as a mobile phone, smartphone, laptop computer, tablet computer, electronic reader, personal digital assistant (PDA), or other type of mobile computing device. In some embodiments, one or more other WCDs may be located within transfer region 303 in addition to WCD 304. The embodiments are not limited in this context.

In various embodiments, wireless charging station 302 may comprise a management component 314. Management component 314 may comprise logic configured to generally manage the operations of PTU 306 in conjunction with the wireless provision of power to WCDs within transfer region 303. In some embodiments, during normal operation, management component 314 may be operative to transition PTU 306 among multiple possible operational state based on detected conditions within transfer region 303. In various embodiments, management component 314 may comprise software logic, hardware logic, or a combination of both. The embodiments are not limited in this context.

In some embodiments, wireless charging station 302 may comprise a communications component 316. Communications component 316 may comprise logic configured to manage communications on the part of wireless charging station 302 with WCDs and/or other devices that may enter transfer region 303 or otherwise move to within wireless communication range of wireless charging station 302. In various embodiments, communications component 316 may be capable of using one or more wireless signaling mechanisms to communicate with such devices. In some embodiments, communications component 316 may comprise software logic, hardware logic, or a combination of both. The embodiments are not limited in this context.

In various embodiments, wireless charging station 302 may comprise one or more radio frequency (RF) transceivers 342. RF transceiver(s) 342 may comprise one or more radios capable of transmitting and receiving signals using various suitable wireless communications techniques. Such techniques may involve communications across one or more wireless networks. Exemplary wireless networks include (but are not limited to) cellular radio access networks, wireless local area networks (WLANs), wireless personal area networks (WPANs), wireless metropolitan area network (WMANs), and satellite networks. In some embodiments, one or more of RF transceiver(s) 342 may be capable of performing wireless communications in a Bluetooth Low Energy (also known as Bluetooth Smart) wireless network according to Bluetooth Core Specification 4.2, released December 2014, and/or any predecessors, progeny, and/or variants thereof. The embodiments are not limited in this context.

In various embodiments, wireless charging station 302 may comprise one or more RF antennas 344. Examples of any particular RF antenna 344 may include, without limitation, an internal antenna, an omni-directional antenna, a monopole antenna, a dipole antenna, an end-fed antenna, a circularly polarized antenna, a micro-strip antenna, a diversity antenna, a dual antenna, a tri-band antenna, a quad-band antenna, and so forth. In some embodiments, RF transceiver(s) 342 may be operative to send and/or receive messages and/or data using one or more RF antennas 344. The embodiments are not limited in this context.

In various embodiments, during normal operation of wireless charging station 302, PTU 306 may be operative to wirelessly transfer power to PRU 308. In some embodiments, PTU 306 may wirelessly transfer power to PRU 308 using a magnetic resonance-based technique, such as resonant inductive coupling. With respect to such embodiments, the term “power transmission frequency” shall be employed hereinafter to denote the frequency of the magnetic resonance via which the power is wirelessly transferred. In various embodiments, PTU 306 may wirelessly transfer power to PRU 308 according to a substantially fixed power transmission frequency. In some embodiments, for example, PTU 306 may wirelessly transfer power to PRU 308 according to a substantially fixed power transmission frequency of 6.78 MHz. The embodiments are not limited to this example.

In various embodiments, PTU 306 may be capable of communicating with PRU 308 using an in-band signaling mechanism. In some such embodiments, communications with PRU 308 using the in-band signaling mechanism may be achieved via modulation of the power transmission frequency being used to wirelessly deliver power to PRU 308. In various embodiments, PTU 306 may additionally or alternatively be capable of communicating with PRU 308 using an out-of-band signaling mechanism. In some such embodiments, communications with PRU 308 using the out-of-band signaling mechanism may comprise wireless communications in a wireless network to which PTU 306 and PRU 308 both have connectivity. In various embodiments, for example, PTU 306 and PRU 308 may both possess wireless connectivity to a Bluetooth Low Energy wireless network, and use of the out-of-band signaling mechanism by PTU 306 may involve sending messages to PRU 308 through the Bluetooth Low Energy wireless network. The embodiments are not limited to these examples.

In some embodiments, during operation of PTU 306 in a power transfer state in which it wirelessly transfers power to WCD 304, management component 314 may perform an extraneous object detection procedure in order to check for the presence of extraneous objects within transfer region 303. In various embodiments, wireless charging station 302 may repeatedly perform the extraneous object detection procedure at regular time intervals. In some embodiments, during the extraneous object detection procedure, management component 314 may check for the presence of extraneous objects within transfer region 303 by analyzing measurements of reflected impedance at PTU 306. The embodiments are not limited in this context.

In various embodiments, during the extraneous object detection procedure, management component 314 may detect the presence of an extraneous object 318 within transfer region 303. In some embodiments, management component 314 may determine whether the extraneous object 318 comprises a foreign object or a rogue object. In various embodiments, management component 314 may perform this determination by analyzing the real and imaginary components of the reflected impedance at PTU 306. The embodiments are not limited in this context.

In some embodiments, in response to detection of extraneous object 318, communications component 316 may be operative to cause transmission of an extraneous object notification message 320 in order to notify WCD 304 of the presence of extraneous object 318 within the transfer field 303 of wireless charging station 302. In various embodiments, extraneous object notification message 320 may simply indicate that at least one extraneous object has been detected within transfer field 303. In some other embodiments, extraneous object notification message 320 may include additional detail regarding any extraneous object(s) detected during the extraneous object detection procedure. For example, in various embodiments, extraneous object notification message 320 may include information specifying whether any rogue objects are comprised among the detected extraneous object(s). In another example, in some embodiments, extraneous object notification message 320 may include information indicating an estimated reduction in charging efficiency caused by the presence of the detected extraneous object(s). The embodiments are not limited to these examples.

In various embodiments, communications component 316 may be operative to cause extraneous object notification message 320 to be transmitted using an in-band signaling mechanism. For example, in some embodiments, communications component 316 may be operative to cause PTU 306 to transmit extraneous object notification message 320 by modulating its power transmission frequency. In various such embodiments, PRU 308 may analyze characteristics of the magnetically-induced current at PRU 308 using signal processing techniques in order to detect the modulation of the power transmission frequency and receive extraneous object notification message 320 according to the in-band signaling mechanism. In some embodiments, communications component 316 may be operative to cause extraneous object notification message 320 to be transmitted using an out-of-band signaling mechanism. For example, in various embodiments, communications component 316 may be operative on one or more RF transceivers 342 and one or more RF antennas 344 to send extraneous object notification message 320 to PRU 308 via a Bluetooth Low Energy wireless network connection. In some such embodiments, WCD 304 may comprise one or more RF transceivers and one or more RF antennas, via which it may receive extraneous object notification message 320 according to the out-of-band signaling mechanism. The embodiments are not limited in this context.

In various embodiments, after the transmission of extraneous object notification message 320, management component 314 may proceed in a manner determined based on whether extraneous object 318 is a rogue object. In some embodiments, in response to a determination that extraneous object 318 is not a rogue object, management component 314 may be operative to maintain PTU 306 in the power transfer state. In various embodiments, in response to a determination that extraneous object 318 is a rogue object, management component 314 may be operative to transition PTU 306 out of the power transfer state and into a non-transfer state. In some embodiments, the non-transfer state may comprise a latching fault state. In various embodiments, management component 314 may be configured to wait until a state transition delay interval has elapsed before transitioning PTU 306 out of the power transfer state, rather than immediately initiating this transition. In some such embodiments, the duration of the state transition delay interval may be determined according to a programmable delay parameter. The embodiments are not limited in this context.

In various embodiments, in response to receipt of extraneous object notification message 320, PRU 308 may be operative to initiate a user alert procedure in order to alert a user of WCD 304 of the presence of extraneous object 318 within transfer field 303. In some embodiments, according to the user alert procedure, PRU 308 may trigger an application at WCD 304 to cause an alert 322 to be presented by WCD 304. In some embodiments, WCD 304 may comprise a host 309, and PRU 308 may cause the host 309 to present alert 322. In various embodiments, alert 322 may generally comprise a set of one or more sensory effects designed to capture the attention of a user and inform the user that an extraneous object has been detected within the transfer field 303 in which WCD 304 resides. In some embodiments, the one or more sensory effects that constitute alert 322 may include one or more visual effects, such as message boxes, dialog windows, prompt screens, icons, and/or other visual effects. In various embodiments, the one or more sensory effects that constitute alert 322 may include one or more audio effects, such as alarms, chimes, tones, speech, and/or other audio effects. In some embodiments, the one or more sensory effects that constitute alert 322 may include one or more tactile effects, such as vibration. The embodiments are not limited in this context.

In various embodiments, according to the user alert procedure, PRU 308 may trigger an application at WCD 304 to cause an alert 326 to be presented by a mobile device 324. In some embodiments, mobile device 324 may comprise a device that is associated with a same user as is WCD 304. In various embodiments, alert 326 may generally comprise a set of one or more sensory effects designed to capture the attention of a user and inform the user that an extraneous object has been detected within the transfer field 303 in which WCD 304 resides. Examples of the various types of sensory effects that may constitute alert 326 may include—without limitation—any of the examples previously mentioned in reference to alert 322. In some embodiments in which alerts 322 and 326 are both presented, alert 326 may be the same as—or similar to—alert 322. In various other such embodiments, alert 326 may substantially differ from alert 322. In some embodiments in which alert 326 is presented at mobile device 324, alert 322 may not be presented at WCD 304. The embodiments are not limited in this context.

In various embodiments, in order to cause alert 326 to be presented at mobile device 324, PRU 308 may be operative to cause transmission of an alert forwarding message 328. In various embodiments, alert forwarding message 328 may be generated by host 309. In some embodiments, as illustrated by path 330 in FIG. 3, alert forwarding message 328 may comprise a message that is directly transmitted from WCD 304 to mobile device 324. In various embodiments, for example, alert forwarding message 328 may comprise a device-to-device (D2D) transmission from WCD 304 to mobile device 324. In some other embodiments, as illustrated by path 332 in FIG. 3, alert forwarding message 328 may comprise a message that is sent to mobile device 324 via one or more intermediate nodes 334. In various embodiments, for example, alert forwarding message 328 may comprise an SMS message that is sent to mobile device 324 via an SMS server. In another example, in some embodiments, alert forwarding message 328 may comprise an email message that mobile device 324 receives using wireless connectivity with a cellular radio access network, a wireless local area network (WLAN), or another type of wireless network. The embodiments are not limited to these examples.

In a non-limiting example embodiment, WCD 304 may comprise a user's laptop computer, and mobile device 324 may comprise that user's mobile phone. In this example, in order to notify the laptop user that an extraneous object has been detected in the transfer field 303 in which his/her laptop computer resides, PRU 308 may initiate a user alert procedure. During the user alert procedure, PRU 308 may cause the laptop computer to present alert 322, which may comprise an alert window displayed on the laptop's screen and an alarm tone generated by the laptop's speakers. Additionally or alternatively, PRU 308 may cause WCD 304 to send an alert forwarding message 328 that comprises an SMS message to be pushed to the user's mobile phone by a cellular service provider network, and alert 326 may comprise the presentation of that SMS message upon its arrival at the mobile phone. The embodiments are not limited to this example.

It is worthy of note that in various embodiments, alerts 322 and/or 326 may be customized based on information comprised in extraneous object notification message 320 describing characteristics of the extraneous object(s) detected within transfer field 303. For example, in some embodiments, alerts 322 and/or 326 may include indications of whether the detected extraneous object(s) include any rogue object(s). In another example, in various embodiments, alerts 322 and/or 326 may include indications of estimated reductions in charging efficiency caused by the presence of the detected extraneous object(s). The embodiments are not limited to these examples.

Operations for the above embodiments may be further described with reference to the following figures and accompanying examples. Some of the figures may include a logic flow. Although such figures presented herein may include a particular logic flow, it can be appreciated that the logic flow merely provides an example of how the general functionality as described herein can be implemented. Further, the given logic flow does not necessarily have to be executed in the order presented unless otherwise indicated. In addition, the given logic flow may be implemented by a hardware element, a software element executed by a processor, or any combination thereof. The embodiments are not limited in this context.

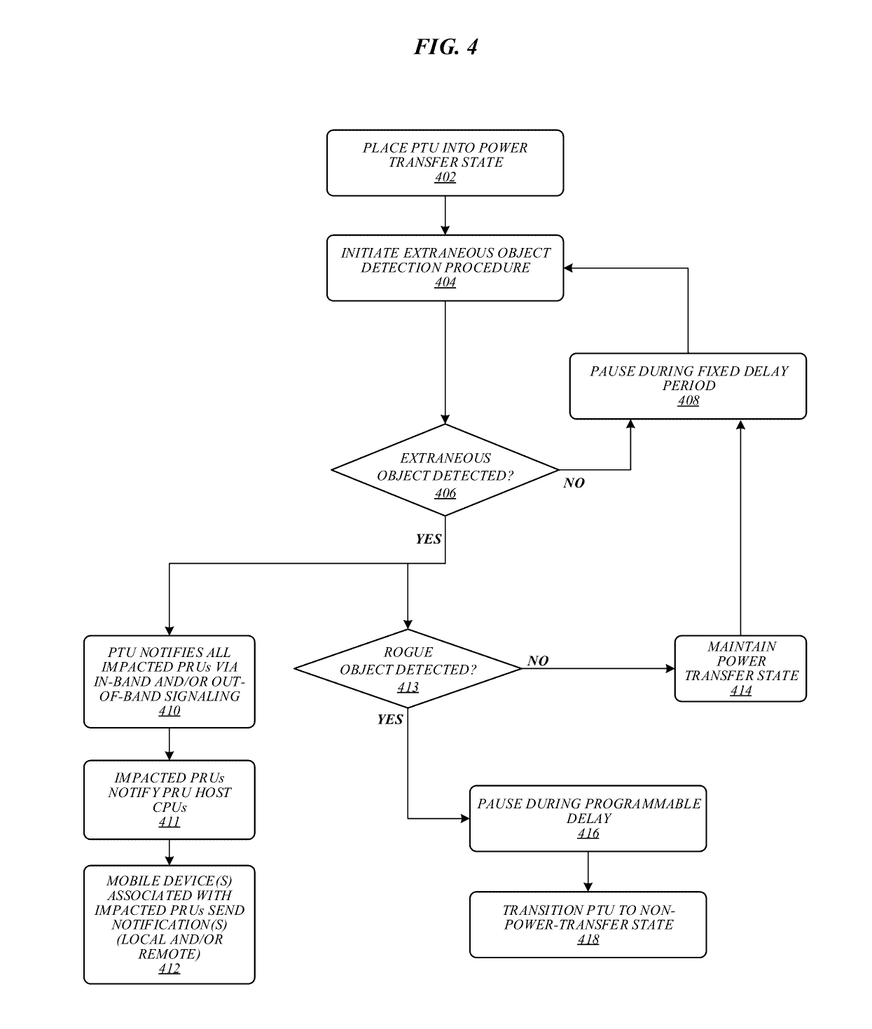

FIG. 4 illustrates an embodiment of a logic flow 400 that may be representative of the implementation of the disclosed notification techniques for wireless power transfer systems in some embodiments. For example, logic flow 400 may be representative of operations that may be performed in various embodiments at wireless charging station 302 of FIG. 3. As shown in FIG. 4, a PTU may be placed into a power transfer state at 402. For example, management component 314 of FIG. 3 may be operative to place PTU 306 into a power transfer state. At 404, an extraneous object detection procedure may be initiated. For example, management component 314 of FIG. 3 may be operative to initiate an extraneous object detection procedure to check for the presence of extraneous objects within transfer field 303. From 404, flow may pass to 406, from which flow may then proceed based on whether any extraneous objects were detected during the extraneous object detection procedure at 404. If no extraneous object was detected, flow may pass to 408. At 408, flow may pause during a fixed delay period, after which flow may return to 404, where the extraneous object detection procedure may be repeated. For example, if management component 314 of FIG. 3 does not detect any extraneous objects during an extraneous object detection procedure, it may wait for a fixed delay period, such as 250 ms, and then perform the extraneous object detection procedure again.

If at least one extraneous object was detected during the extraneous object detection procedure at 404, flow may pass from 406 along two parallel paths. Along one path, flow may pass from 406 to 410, where one or more extraneous object notification messages may be sent in order to notify all affected PRUs of the detection of the extraneous object by the PTU. For example, communications component 316 of FIG. 3 may be operative to one or more send extraneous object notification messages 320 in order to notify all affected PRUs of the detection of the extraneous object by PTU 306. At 411, each impacted PRU may notify its host CPU of receipt of an extraneous object notification message sent by the PTU. At 412, mobile devices associated with the affected PRUs may send local or remote notifications to inform other devices of the detection of the extraneous object.

Along a parallel path, flow may pass from 406 to 413, from which flow may then proceed based on whether any detected extraneous object comprises a rogue object. If no rogue object has been detected, flow may pass from 413 to 414, where the PTU may be maintained in the power transfer state. From 414, flow may pass to 408. If at least one rogue object was detected during the extraneous object detection procedure at 404, flow may pass from 413 to 416. At 416, flow may pause during a programmable delay, after which the PTU may be transferred to a non-power-transfer state at 418. For example, if management component 314 detects at least one rogue object during an extraneous object detection procedure, it may wait for a programmable delay and then transition PTU to a latching fault state. In various embodiments, the programmable delay may be selected to cover the time needed for completion of the operations at 410 and 411. The embodiments are not limited to these examples.

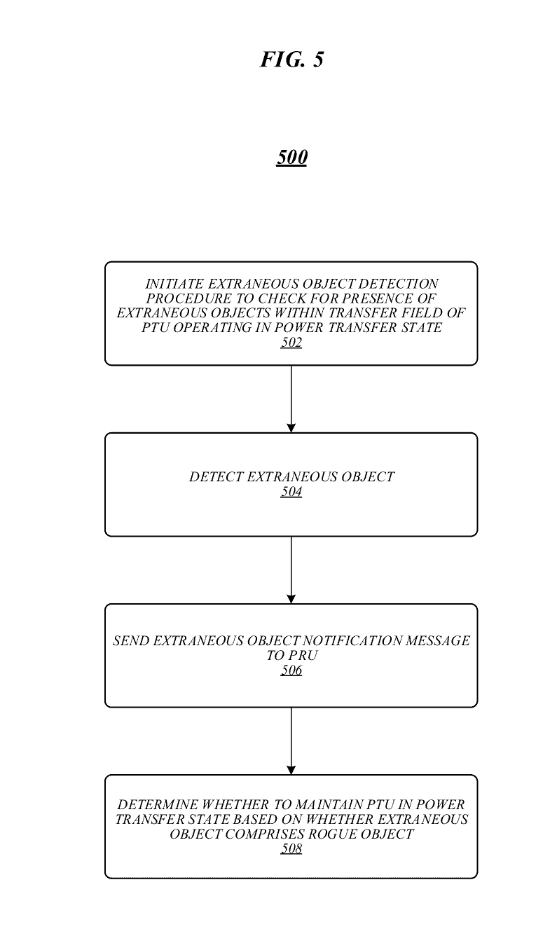

FIG. 5 illustrates an embodiment of a logic flow 500 that may be representative of the implementation of the disclosed notification techniques for wireless power transfer systems in some embodiments. For example, logic flow 500 may be representative of operations that may be performed in various embodiments at wireless charging station 302 of FIG. 3. As shown in FIG. 5, an extraneous object detection procedure may be initiated at 502 in order to check for the presence of extraneous objects within a transfer field of a PTU operating in a power transfer state. For example, while PTU 306 of FIG. 3 operates in a power transfer state, management component 314 may initiate an extraneous object detection procedure in order to check for the presence of extraneous objects within transfer field 303.

At 504, an extraneous object may be detected. For example, management component 314 of FIG. 3 may detect extraneous object 318. At 506, an extraneous object notification message may be sent to a PRU. For example, communications component 316 of FIG. 3 may send extraneous object notification message 320 to PRU 308. At 508, it may be determined whether to maintain the PTU in the power transfer state based on whether the extraneous object comprises a rogue object. For example, management component 314 of FIG. 3 may determine whether to maintain PTU 306 in the power transfer state based on a determination of whether extraneous object 318 comprises a rogue object. The embodiments are not limited to these examples.

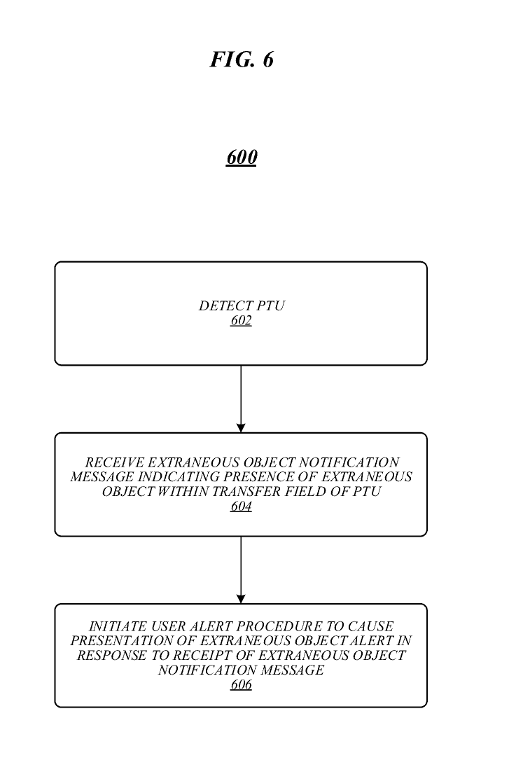

FIG. 6 illustrates an embodiment of a logic flow 600 that may be representative of the implementation of the disclosed notification techniques for wireless power transfer systems in some embodiments. For example, logic flow 600 may be representative of operations that may be performed in various embodiments at WCD 304 of FIG. 3. As shown in FIG. 6, a PTU may be detected at 602. For example, WCD 304 of FIG. 3 may detect the PTU 306 comprised in wireless charging station 302. At 604, an extraneous object notification message may be received that indicates a presence of an extraneous object within a transfer field of the PTU. For example, WCD 304 of FIG. 3 may receive extraneous object notification message 320, which may indicate the presence of extraneous object 318 within the transfer field 303 of PTU 306. At 606, a user alert procedure may be initiated in response to receipt of the extraneous object notification message, in order to cause the presentation of an extraneous object alert. For example, WCD 304 of FIG. 3 may initiate a user alert procedure in response to receipt of extraneous object notification message 320, in order to cause alert 322 to be presented at WCD 304 and/or to cause alert 326 to be presented at mobile device 324. The embodiments are not limited to these examples.

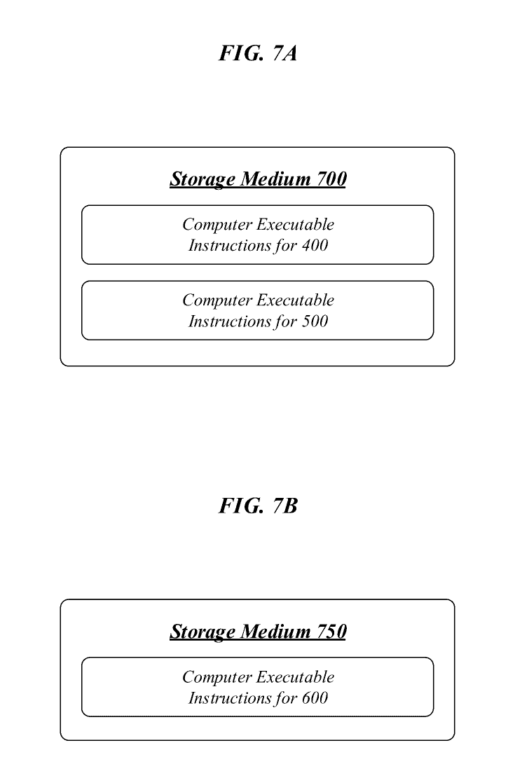

FIG. 7A illustrates an embodiment of a storage medium 700. Storage medium 700 may comprise any non-transitory computer-readable storage medium or machine-readable storage medium, such as an optical, magnetic or semiconductor storage medium. In various embodiments, storage medium 700 may comprise an article of manufacture. In some embodiments, storage medium 700 may store computer-executable instructions, such as computer-executable instructions to implement one or both of logic flow 400 of FIG. 4 and logic flow 500 of FIG. 5. Examples of a computer-readable storage medium or machine-readable storage medium may include any tangible media capable of storing electronic data, including volatile memory or non-volatile memory, removable or non-removable memory, erasable or non-erasable memory, writeable or re-writeable memory, and so forth. Examples of computer-executable instructions may include any suitable type of code, such as source code, compiled code, interpreted code, executable code, static code, dynamic code, object-oriented code, visual code, and the like. The embodiments are not limited in this context.

FIG. 7B illustrates an embodiment of a storage medium 750. Storage medium 750 may comprise any non-transitory computer-readable storage medium or machine-readable storage medium, such as an optical, magnetic or semiconductor storage medium. In various embodiments, storage medium 750 may comprise an article of manufacture. In some embodiments, storage medium 750 may store computer-executable instructions, such as computer-executable instructions to implement logic flow 600 of FIG. 6. Examples of a computer-readable or machine-readable storage medium and of computer-executable instructions may include—without limitation—any of the respective examples mentioned above in reference to storage medium 700 of FIG. 7A. The embodiments are not limited in this context.

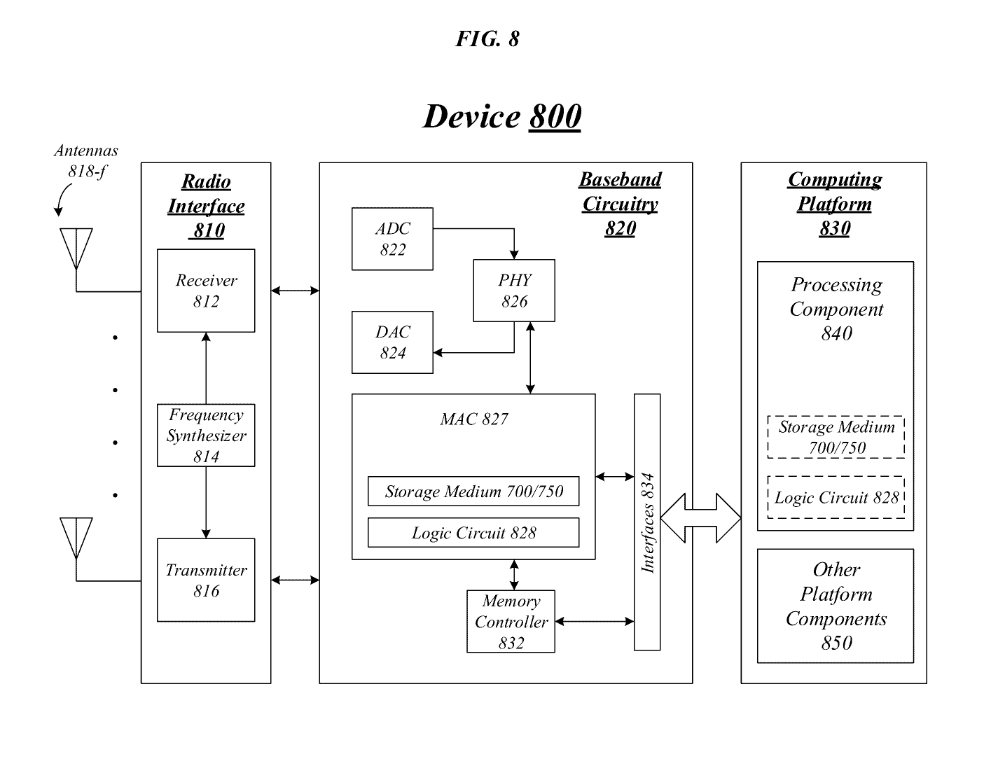

FIG. 8 illustrates an embodiment of a communications device 800 that may implement one or more of wireless charging station 102 and WCDs 104 of FIGS. 1 and 2, wireless charging station 302, WCD 304 and mobile device 324 of FIG. 3, logic flow 400 of FIG. 4, logic flow 500 of FIG. 5, logic flow 600 of FIG. 6, storage medium 700 of FIG. 7A, and storage medium 750 of FIG. 7B. In various embodiments, device 800 may comprise a logic circuit 828. The logic circuit 828 may include physical circuits to perform operations described for one or more of wireless charging station 102 and WCDs 104 of FIGS. 1 and 2, wireless charging station 302, WCD 304 and mobile device 324 of FIG. 3, logic flow 400 of FIG. 4, logic flow 500 of FIG. 5, and logic flow 600 of FIG. 6, for example. As shown in FIG. 8, device 800 may include a radio interface 810, baseband circuitry 820, and computing platform 830, although the embodiments are not limited to this configuration.

The device 800 may implement some or all of the structure and/or operations for one or more of wireless charging station 102 and WCDs 104 of FIGS. 1 and 2, wireless charging station 302, WCD 304 and mobile device 324 of FIG. 3, logic flow 400 of FIG. 4, logic flow 500 of FIG. 5, logic flow 600 of FIG. 6, storage medium 700 of FIG. 7A, storage medium 750 of FIG. 7B, and logic circuit 828 in a single computing entity, such as entirely within a single device. Alternatively, the device 800 may distribute portions of the structure and/or operations for one or more of wireless charging station 102 and WCDs 104 of FIGS. 1 and 2, wireless charging station 302, WCD 304 and mobile device 324 of FIG. 3, logic flow 400 of FIG. 4, logic flow 500 of FIG. 5, logic flow 600 of FIG. 6, storage medium 700 of FIG. 7A, storage medium 750 of FIG. 7B, and logic circuit 828 across multiple computing entities using a distributed system architecture, such as a client-server architecture, a 3-tier architecture, an N-tier architecture, a tightly-coupled or clustered architecture, a peer-to-peer architecture, a master-slave architecture, a shared database architecture, and other types of distributed systems. The embodiments are not limited in this context.

In one embodiment, radio interface 810 may include a component or combination of components adapted for transmitting and/or receiving single-carrier or multi-carrier modulated signals (e.g., including complementary code keying (CCK), orthogonal frequency division multiplexing (OFDM), and/or single-carrier frequency division multiple access (SC-FDMA) symbols) although the embodiments are not limited to any specific over-the-air interface or modulation scheme. Radio interface 810 may include, for example, a receiver 812, a frequency synthesizer 814, and/or a transmitter 816. Radio interface 810 may include bias controls, a crystal oscillator and/or one or more antennas 818-f. In another embodiment, radio interface 810 may use external voltage-controlled oscillators (VCOs), surface acoustic wave filters, intermediate frequency (IF) filters and/or RF filters, as desired. Due to the variety of potential RF interface designs an expansive description thereof is omitted.

Baseband circuitry 820 may communicate with radio interface 810 to process receive and/or transmit signals and may include, for example, an analog-to-digital converter 822 for down converting received signals, a digital-to-analog converter 824 for up converting signals for transmission. Further, baseband circuitry 820 may include a baseband or physical layer (PHY) processing circuit 826 for PHY link layer processing of respective receive/transmit signals. Baseband circuitry 820 may include, for example, a medium access control (MAC) processing circuit 827 for MAC/data link layer processing. Baseband circuitry 820 may include a memory controller 832 for communicating with MAC processing circuit 827 and/or a computing platform 830, for example, via one or more interfaces 834.

In some embodiments, PHY processing circuit 826 may include a frame construction and/or detection module, in combination with additional circuitry such as a buffer memory, to construct and/or deconstruct communication frames. Alternatively or in addition, MAC processing circuit 827 may share processing for certain of these functions or perform these processes independent of PHY processing circuit 826. In some embodiments, MAC and PHY processing may be integrated into a single circuit.

The computing platform 830 may provide computing functionality for the device 800. As shown, the computing platform 830 may include a processing component 840. In addition to, or alternatively of, the baseband circuitry 820, the device 800 may execute processing operations or logic for one or more of wireless charging station 102 and WCDs 104 of FIGS. 1 and 2, wireless charging station 302, WCD 304 and mobile device 324 of FIG. 3, logic flow 400 of FIG. 4, logic flow 500 of FIG. 5, logic flow 600 of FIG. 6, storage medium 700 of FIG. 7A, storage medium 750 of FIG. 7B, and logic circuit 828 using the processing component 840. The processing component 840 (and/or PHY 826 and/or MAC 827) may comprise various hardware elements, software elements, or a combination of both. Examples of hardware elements may include devices, logic devices, components, processors, microprocessors, circuits, processor circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

The computing platform 830 may further include other platform components 850. Other platform components 850 include common computing elements, such as one or more processors, multi-core processors, co-processors, memory units, chipsets, controllers, peripherals, interfaces, oscillators, timing devices, video cards, audio cards, multimedia input/output (I/O) components (e.g., digital displays), power supplies, and so forth. Examples of memory units may include without limitation various types of computer readable and machine readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information.

Device 800 may be, for example, an ultra-mobile device, a mobile device, a fixed device, a machine-to-machine (M2M) device, a personal digital assistant (PDA), a mobile computing device, a smart phone, a telephone, a digital telephone, a cellular telephone, user equipment, eBook readers, a handset, a one-way pager, a two-way pager, a messaging device, a computer, a personal computer (PC), a desktop computer, a laptop computer, a notebook computer, a netbook computer, a handheld computer, a tablet computer, a server, a server array or server farm, a web server, a network server, an Internet server, a work station, a mini-computer, a main frame computer, a supercomputer, a network appliance, a web appliance, a distributed computing system, multiprocessor systems, processor-based systems, consumer electronics, programmable consumer electronics, game devices, display, television, digital television, set top box, wireless access point, base station, node B, subscriber station, mobile subscriber center, radio network controller, router, hub, gateway, bridge, switch, machine, or combination thereof. Accordingly, functions and/or specific configurations of device 800 described herein, may be included or omitted in various embodiments of device 800, as suitably desired.

Embodiments of device 800 may be implemented using single input single output (SISO) architectures. However, certain implementations may include multiple antennas (e.g., antennas 818-f) for transmission and/or reception using adaptive antenna techniques for beamforming or spatial division multiple access (SDMA) and/or using MIMO communication techniques.

The components and features of device 800 may be implemented using any combination of discrete circuitry, application specific integrated circuits (ASICs), logic gates and/or single chip architectures. Further, the features of device 800 may be implemented using microcontrollers, programmable logic arrays and/or microprocessors or any combination of the foregoing where suitably appropriate. It is noted that hardware, firmware and/or software elements may be collectively or individually referred to herein as “logic” or “circuit.”

It should be appreciated that the exemplary device 800 shown in the block diagram of FIG. 8 may represent one functionally descriptive example of many potential implementations. Accordingly, division, omission or inclusion of block functions depicted in the accompanying figures does not infer that the hardware components, circuits, software and/or elements for implementing these functions would be necessarily be divided, omitted, or included in embodiments.

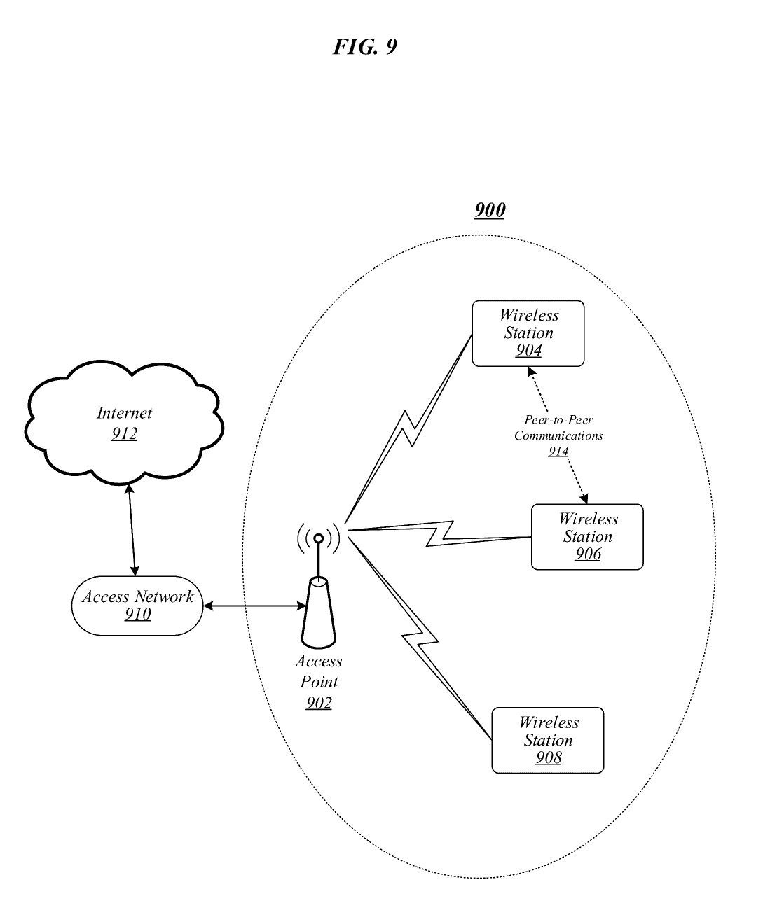

FIG. 9 illustrates an embodiment of a wireless network 900. As shown in FIG. 9, wireless network comprises an access point 902 and wireless stations 904, 906, and 908. In various embodiments, wireless network 900 may comprise a wireless local area network (WLAN), such as a WLAN implementing one or more Institute of Electrical and Electronics Engineers (IEEE) 802.11 standards (sometimes collectively referred to as “Wi-Fi”). In some other embodiments, wireless network 900 may comprise another type of wireless network, and/or may implement other wireless communications standards. In various embodiments, for example, wireless network 900 may comprise a WWAN or WPAN rather than a WLAN. The embodiments are not limited to this example.

In some embodiments, wireless network 900 may implement one or more broadband wireless communications standards, such as 3G or 4G standards, including their revisions, progeny, and variants. Examples of 3G or 4G wireless standards may include without limitation any of the IEEE 802.16m and 802.16p standards, 3rd Generation Partnership Project (3GPP) Long Term Evolution (LTE) and LTE-Advanced (LTE-A) standards, and International Mobile Telecommunications Advanced (IMT-ADV) standards, including their revisions, progeny and variants. Other suitable examples may include, without limitation, Global System for Mobile Communications (GSM)/Enhanced Data Rates for GSM Evolution (EDGE) technologies, Universal Mobile Telecommunications System (UMTS)/High Speed Packet Access (HSPA) technologies, Worldwide Interoperability for Microwave Access (WiMAX) or the WiMAX II technologies, Code Division Multiple Access (CDMA) 2000 system technologies (e.g., CDMA2000 1×RTT, CDMA2000 EV-DO, CDMA EV-DV, and so forth), High Performance Radio Metropolitan Area Network (HIPERMAN) technologies as defined by the European Telecommunications Standards Institute (ETSI) Broadband Radio Access Networks (BRAN), Wireless Broadband (WiBro) technologies, GSM with General Packet Radio Service (GPRS) system (GSM/GPRS) technologies, High Speed Downlink Packet Access (HSDPA) technologies, High Speed Orthogonal Frequency-Division Multiplexing (OFDM) Packet Access (HSOPA) technologies, High-Speed Uplink Packet Access (HSUPA) system technologies, 3GPP Rel. 8-12 of LTE/System Architecture Evolution (SAE), and so forth. The embodiments are not limited in this context.

In various embodiments, wireless stations 904, 906, and 908 may communicate with access point 902 in order to obtain connectivity to one or more external data networks. In some embodiments, for example, wireless stations 904, 906, and 908 may connect to the Internet 912 via access point 902 and access network 910. In various embodiments, access network 910 may comprise a private network that provides subscription-based Internet-connectivity, such as an Internet Service Provider (ISP) network. The embodiments are not limited to this example.

In various embodiments, two or more of wireless stations 904, 906, and 908 may communicate with each other directly by exchanging peer-to-peer communications. For example, in the example of FIG. 9, wireless stations 904 and 906 communicate with each other directly by exchanging peer-to-peer communications 914. In some embodiments, such peer-to-peer communications may be performed according to one or more Wi-Fi Alliance (WFA) standards. For example, in various embodiments, such peer-to-peer communications may be performed according to the WFA Wi-Fi Direct standard, 2010 Release. In various embodiments, such peer-to-peer communications may additionally or alternatively be performed using one or more interfaces, protocols, and/or standards developed by the WFA Wi-Fi Direct Services (WFDS) Task Group. The embodiments are not limited to these examples.

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor. Some embodiments may be implemented, for example, using a machine-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

Example 1 is an apparatus, comprising a power transmitting unit (PTU), and logic, at least a portion of which is in hardware, the logic to initiate an extraneous object detection procedure to check for a presence of extraneous objects within a transfer field of the PTU during operation of the PTU in a power transfer state, and in response to a detection of an extraneous object, send an extraneous object notification message to a remote device and determine whether to maintain the PTU in the power transfer state based on a determination of whether the extraneous object comprises a rogue object.

Example 2 is the apparatus of Example 1, the logic to send the extraneous object notification message to the remote device via an in-band signaling mechanism.

Example 3 is the apparatus of Example 2, the in-band signaling mechanism to comprise modulation of a power transmission frequency of the PTU.

Example 4 is the apparatus of Example 3, the power transmission frequency of the PTU to comprise a substantially fixed power transmission frequency of 6.78 MHz.

Example 5 is the apparatus of Example 1, the logic to send the extraneous object notification message to the remote device via an out-of-band signaling mechanism.

Example 6 is the apparatus of Example 5, the out-of-band signaling mechanism to comprise wireless communication via a Bluetooth Low Energy network.

Example 7 is the apparatus of Example 1, the logic to transition the PTU into a non-transfer state in response to a determination that the extraneous object comprises a rogue object.

Example 8 is the apparatus of Example 7, the non-transfer state to comprise a latching fault state.

Example 9 is the apparatus of Example 1, the logic to maintain the PTU in the power transfer state in response to a determination that the extraneous object does not comprise a rogue object.

Example 10 is the apparatus of Example 1, the extraneous object notification message to include information indicating whether the extraneous object comprises a rogue object.

Example 11 is the apparatus of Example 1, the extraneous object notification message to include information indicating an estimated charging efficiency reduction associated with the presence of the extraneous object in the transfer field of the PTU.

Example 12 is a wirelessly-chargeable device, comprising a power receiving unit (PRU) to receive power from a power transmitting unit (PTU) comprised in a remote device, and logic, at least a portion of which is in hardware, the logic to receive an extraneous object notification message indicating a presence of an extraneous object within a transfer field of the PTU and in response to receipt of the extraneous object notification message, initiate a user alert procedure to cause presentation of an extraneous object alert.

Example 13 is the wirelessly-chargeable device of Example 12, the extraneous object alert to specify whether the extraneous object comprises a rogue object.

Example 14 is the wirelessly-chargeable device of Example 12, the user alert procedure to comprise presenting the extraneous object alert at the wirelessly-chargeable device.

Example 15 is the wirelessly-chargeable device of Example 12, the user alert procedure to comprise sending an alert forwarding message to cause presentation of the extraneous object alert at a mobile device.

Example 16 is the wirelessly-chargeable device of Example 15, the extraneous object alert to comprise a short message service (SMS) message.

Example 17 is the wirelessly-chargeable device of Example 15, the extraneous object alert to comprise an email message.

Example 18 is the wirelessly-chargeable device of Example 15, the user alert procedure to comprise presenting a second extraneous object alert at the wirelessly-chargeable device.

Example 19 is the wirelessly-chargeable device of Example 12, the logic to receive the extraneous object notification message from the PTU via an in-band signaling mechanism.

Example 20 is the wirelessly-chargeable device of Example 19, the in-band signaling mechanism comprising modulation of a power transmission frequency of the PTU.

Example 21 is the wirelessly-chargeable device of Example 12, the logic to receive the extraneous object notification message from the remote device via an out-of-band signaling mechanism.

Example 22 is the wirelessly-chargeable device of Example 21, the out-of-band signaling mechanism to comprise wireless communication via a Bluetooth Low Energy network.

Example 23 is the wirelessly-chargeable device of Example 12, comprising at least one radio frequency (RF) transceiver, and at least one RF antenna.

Example 24 is at least one non-transitory computer-readable storage medium comprising a set of instructions that, in response to being executed at a wireless power transfer device, cause the wireless power transfer device to initiate an extraneous object detection procedure to check for a presence of extraneous objects within a transfer field of a power transmitting unit (PTU) of the wireless power transfer device during operation of the PTU in a power transfer state, and in response to a detection of an extraneous object send an extraneous object notification message to a remote device, and determine whether to maintain the PTU in the power transfer state based on a determination of whether the extraneous object comprises a rogue object.

Example 25 is the at least one non-transitory computer-readable storage medium of Example 24, comprising instructions that, in response to being executed at the wireless power transfer device, cause the wireless power transfer device to send the extraneous object notification message to the remote device via an in-band signaling mechanism.

Example 26 is the at least one non-transitory computer-readable storage medium of Example 25, the in-band signaling mechanism comprising modulation of a power transmission frequency of the PTU.

Example 27 is the at least one non-transitory computer-readable storage medium of Example 26, the power transmission frequency of the PTU to comprise a substantially fixed power transmission frequency of 6.78 MHz.

Example 28 is the at least one non-transitory computer-readable storage medium of Example 24, comprising instructions that, in response to being executed at the wireless power transfer device, cause the wireless power transfer device to send the extraneous object notification message to the remote device via an out-of-band signaling mechanism.

Example 29 is the at least one non-transitory computer-readable storage medium of Example 28, the out-of-band signaling mechanism to comprise wireless communication via a Bluetooth Low Energy network.

Example 30 is the at least one non-transitory computer-readable storage medium of Example 24, comprising instructions that, in response to being executed at the wireless power transfer device, cause the wireless power transfer device to transition the PTU into a non-transfer state in response to a determination that the extraneous object comprises a rogue object.

Example 31 is the at least one non-transitory computer-readable storage medium of Example 30, the non-transfer state to comprise a latching fault state.

Example 32 is the at least one non-transitory computer-readable storage medium of Example 24, comprising instructions that, in response to being executed at the wireless power transfer device, cause the wireless power transfer device to maintain the PTU in the power transfer state in response to a determination that the extraneous object does not comprise a rogue object.

Example 33 is the at least one non-transitory computer-readable storage medium of Example 24, the extraneous object notification message to include information indicating whether the extraneous object comprises a rogue object.

Example 34 is the at least one non-transitory computer-readable storage medium of Example 24, the extraneous object notification message to include information indicating an estimated charging efficiency reduction associated with the presence of the extraneous object in the transfer field of the PTU.

Example 35 is at least one non-transitory computer-readable storage medium comprising a set of instructions that, in response to being executed at a wirelessly-chargeable device, cause the wirelessly-chargeable device to detect a power transmitting unit (PTU) comprised in a remote device, receive an extraneous object notification message indicating a presence of an extraneous object within a transfer field of the PTU, and in response to receipt of the extraneous object notification message, initiate a user alert procedure to cause presentation of an extraneous object alert.

Example 36 is the at least one non-transitory computer-readable storage medium of Example 35, the extraneous object alert to specify whether the extraneous object comprises a rogue object.

Example 37 is the at least one non-transitory computer-readable storage medium of Example 35, the user alert procedure to comprise presenting the extraneous object alert at the wirelessly-chargeable device.

Example 38 is the at least one non-transitory computer-readable storage medium of Example 35, the user alert procedure to comprise sending an alert forwarding message to cause presentation of the extraneous object alert at a mobile device.

Example 39 is the at least one non-transitory computer-readable storage medium of Example 38, the extraneous object alert to comprise a short message service (SMS) message.

Example 40 is the at least one non-transitory computer-readable storage medium of Example 38, the extraneous object alert to comprise an email message.

Example 41 is the at least one non-transitory computer-readable storage medium of Example 38, the user alert procedure to comprise presenting a second extraneous object alert at the wirelessly-chargeable device.

Example 42 is the at least one non-transitory computer-readable storage medium of Example 35, comprising instructions that, in response to being executed at the wirelessly-chargeable device, cause the wirelessly-chargeable device to receive the extraneous object notification message from the PTU via an in-band signaling mechanism.

Example 43 is the at least one non-transitory computer-readable storage medium of Example 42, the in-band signaling mechanism comprising modulation of a power transmission frequency of the PTU.

Example 44 is the at least one non-transitory computer-readable storage medium of Example 35, comprising instructions that, in response to being executed at the wirelessly-chargeable device, cause the wirelessly-chargeable device to receive the extraneous object notification message from the remote device via an out-of-band signaling mechanism.

Example 45 is the at least one non-transitory computer-readable storage medium of Example 44, the out-of-band signaling mechanism to comprise wireless communication via a Bluetooth Low Energy network.

Example 46 is a method, comprising initiating, at a wireless power transfer device, an extraneous object detection procedure to check for a presence of extraneous objects within a transfer field of a power transmitting unit (PTU) of the wireless power transfer device during operation of the PTU in a power transfer state, and in response to a detection of an extraneous object sending an extraneous object notification message to a remote device, and determining whether to maintain the PTU in the power transfer state based on a determination of whether the extraneous object comprises a rogue object.

Example 47 is the method of Example 46, comprising sending the extraneous object notification message to the remote device via an in-band signaling mechanism.

Example 48 is the method of Example 47, the in-band signaling mechanism comprising modulation of a power transmission frequency of the PTU.

Example 49 is the method of Example 48, the power transmission frequency of the PTU to comprise a substantially fixed power transmission frequency of 6.78 MHz.

Example 50 is the method of Example 46, comprising sending the extraneous object notification message to the remote device via an out-of-band signaling mechanism.

Example 51 is the method of Example 50, the out-of-band signaling mechanism to comprise wireless communication via a Bluetooth Low Energy network.

Example 52 is the method of Example 46, comprising transitioning the PTU into a non-transfer state in response to a determination that the extraneous object comprises a rogue object.

Example 53 is the method of Example 52, the non-transfer state to comprise a latching fault state.

Example 54 is the method of Example 46, comprising maintaining the PTU in the power transfer state in response to a determination that the extraneous object does not comprise a rogue object.

Example 55 is the method of Example 46, the extraneous object notification message to include information indicating whether the extraneous object comprises a rogue object.

Example 56 is the method of Example 46, the extraneous object notification message to include information indicating an estimated charging efficiency reduction associated with the presence of the extraneous object in the transfer field of the PTU.

Example 57 is at least one non-transitory computer-readable storage medium comprising a set of instructions that, in response to being executed on a computing device, cause the computing device to perform a method according to any of Examples 46 to 56.

Example 58 is an apparatus comprising means for performing a method according to any of Examples 46 to 56.

Example 59 is a method, comprising detecting, by a wirelessly-chargeable device, a power transmitting unit (PTU) comprised in a remote device, receiving an extraneous object notification message indicating a presence of an extraneous object within a transfer field of the PTU, and in response to receipt of the extraneous object notification message, initiating a user alert procedure to cause presentation of an extraneous object alert.

Example 60 is the method of Example 59, the extraneous object alert to specify whether the extraneous object comprises a rogue object.

Example 61 is the method of Example 59, the user alert procedure to comprise presenting the extraneous object alert at the wirelessly-chargeable device.

Example 62 is the method of Example 59, the user alert procedure to comprise sending an alert forwarding message to cause presentation of the extraneous object alert at a mobile device.

Example 63 is the method of Example 62, the extraneous object alert to comprise a short message service (SMS) message.

Example 64 is the method of Example 62, the extraneous object alert to comprise an email message.

Example 65 is the method of Example 62, the user alert procedure to comprise presenting a second extraneous object alert at the wirelessly-chargeable device.

Example 66 is the method of Example 59, comprising receiving the extraneous object notification message from the PTU via an in-band signaling mechanism.

Example 67 is the method of Example 66, the in-band signaling mechanism comprising modulation of a power transmission frequency of the PTU.

Example 68 is the method of Example 59, comprising receiving the extraneous object notification message from the remote device via an out-of-band signaling mechanism.

Example 69 is the method of Example 68, the out-of-band signaling mechanism to comprise wireless communication via a Bluetooth Low Energy network.

Example 70 is at least one non-transitory computer-readable storage medium comprising a set of instructions that, in response to being executed on a computing device, cause the computing device to perform a method according to any of Examples 59 to 69.

Example 71 is an apparatus comprising means for performing a method according to any of Examples 59 to 69.

Example 72 is an apparatus, comprising a power transmitting unit (PTU), and logic, at least a portion of which is in hardware, the logic to initiate an extraneous object detection procedure to check for a presence of extraneous objects within a transfer field of the PTU during operation of the PTU in a power transfer state, and in response to a detection of an extraneous object, send an extraneous object notification message to a power receiving unit (PRU) and determine whether to maintain the PTU in the power transfer state based on a determination of whether the extraneous object comprises a rogue object.

Example 73 is the apparatus of Example 72, the logic to send the extraneous object notification message to the PRU via an in-band signaling mechanism.

Example 74 is the apparatus of Example 73, the in-band signaling mechanism comprising modulation of a power transmission of the PTU.

Example 75 is the apparatus of Example 72, the logic to send the extraneous object notification message to the PRU via an out-of-band signaling mechanism.

Example 76 is the apparatus of Example 75, the out-of-band signaling mechanism to comprise wireless communication via a Bluetooth Low Energy network.

Example 77 is the apparatus of Example 72, the logic to transition the PTU into a non-power-transfer state in response to a determination that the extraneous object comprises a rogue object.

Example 78 is the apparatus of Example 77, the non-power-transfer state to comprise a latching fault state.

Example 79 is the apparatus of Example 77, the logic to enforce a programmable delay prior to transitioning the PTU into the non-power-transfer state.

Example 80 is the apparatus of Example 72, the logic to maintain the PTU in the power transfer state in response to a determination that the extraneous object does not comprise a rogue object.

Example 81 is a wirelessly-chargeable device, comprising a power receiving unit (PRU) to receive power from a power transmitting unit (PTU), and logic, at least a portion of which is in hardware, the logic to receive an extraneous object notification message indicating a presence of an extraneous object within a transfer field of the PTU and in response to receipt of the extraneous object notification message, initiate a user alert procedure to cause presentation of an extraneous object alert.

Example 82 is the wirelessly-chargeable device of Example 81, the user alert procedure to comprise presenting the extraneous object alert at the wirelessly-chargeable device.

Example 83 is the wirelessly-chargeable device of Example 81, the user alert procedure to comprise sending an alert forwarding message to cause presentation of the extraneous object alert at a remote mobile device.

Example 84 is the wirelessly-chargeable device of Example 81, the logic to receive the extraneous object notification message from the remote device via an out-of-band signaling mechanism.

Example 85 is the wirelessly-chargeable device of Example 84, the out-of-band signaling mechanism to comprise wireless communication via a Bluetooth Low Energy network.

Example 86 is the wirelessly-chargeable device of Example 81, comprising at least one processor, and at least one memory.

Example 87 is the wirelessly-chargeable device of Example 86, comprising at least one radio frequency (RF) transceiver, and at least one RF antenna.

Example 88 is at least one non-transitory computer-readable storage medium comprising a set of instructions that, in response to being executed at a wireless power transfer device, cause the wireless power transfer device to initiate an extraneous object detection procedure to check for a presence of extraneous objects within a transfer field of a power transmitting unit (PTU) of the wireless power transfer device during operation of the PTU in a power transfer state, and in response to a detection of an extraneous object send an extraneous object notification message to a power receiving unit (PRU), and determine whether to maintain the PTU in the power transfer state based on a determination of whether the extraneous object comprises a rogue object.

Example 89 is the at least one non-transitory computer-readable storage medium of Example 88, comprising instructions that, in response to being executed at the wireless power transfer device, cause the wireless power transfer device to send the extraneous object notification message to the PRU via an in-band signaling mechanism.

Example 90 is the at least one non-transitory computer-readable storage medium of Example 89, the in-band signaling mechanism comprising modulation of a power transmission of the PTU.

Example 91 is the at least one non-transitory computer-readable storage medium of Example 88, comprising instructions that, in response to being executed at the wireless power transfer device, cause the wireless power transfer device to send the extraneous object notification message to the PRU via an out-of-band signaling mechanism.

Example 92 is the at least one non-transitory computer-readable storage medium of Example 91, the out-of-band signaling mechanism to comprise wireless communication via a Bluetooth Low Energy network.

Example 93 is the at least one non-transitory computer-readable storage medium of Example 88, comprising instructions that, in response to being executed at the wireless power transfer device, cause the wireless power transfer device to transition the PTU into a non-transfer state in response to a determination that the extraneous object comprises a rogue object.

Example 94 is the at least one non-transitory computer-readable storage medium of Example 93, the non-transfer state to comprise a latching fault state.

Example 95 is the at least one non-transitory computer-readable storage medium of Example 93, comprising instructions that, in response to being executed at the wireless power transfer device, cause the wireless power transfer device to enforce a programmable delay prior to transitioning the PTU into the non-power-transfer state.

Example 96 is the at least one non-transitory computer-readable storage medium of Example 88, comprising instructions that, in response to being executed at the wireless power transfer device, cause the wireless power transfer device to maintain the PTU in the power transfer state in response to a determination that the extraneous object does not comprise a rogue object.

Numerous specific details have been set forth herein to provide a thorough understanding of the embodiments. It will be understood by those skilled in the art, however, that the embodiments may be practiced without these specific details. In other instances, well-known operations, components, and circuits have not been described in detail so as not to obscure the embodiments. It can be appreciated that the specific structural and functional details disclosed herein may be representative and do not necessarily limit the scope of the embodiments.

Some embodiments may be described using the expression “coupled” and “connected” along with their derivatives. These terms are not intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

Unless specifically stated otherwise, it may be appreciated that terms such as “processing,” “computing,” “calculating,” “determining,” or the like, refer to the action and/or processes of a computer or computing system, or similar electronic computing device, that manipulates and/or transforms data represented as physical quantities (e.g., electronic) within the computing system's registers and/or memories into other data similarly represented as physical quantities within the computing system's memories, registers or other such information storage, transmission or display devices. The embodiments are not limited in this context.

It should be noted that the methods described herein do not have to be executed in the order described, or in any particular order. Moreover, various activities described with respect to the methods identified herein can be executed in serial or parallel fashion.

Although specific embodiments have been illustrated and described herein, it should be appreciated that any arrangement calculated to achieve the same purpose may be substituted for the specific embodiments shown. This disclosure is intended to cover any and all adaptations or variations of various embodiments. It is to be understood that the above description has been made in an illustrative fashion, and not a restrictive one. Combinations of the above embodiments, and other embodiments not specifically described herein will be apparent to those of skill in the art upon reviewing the above description. Thus, the scope of various embodiments includes any other applications in which the above compositions, structures, and methods are used.

It is emphasized that the Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate preferred embodiment. In the appended claims, the terms “including” and “in which” are used as the plain-English equivalents of the respective terms “comprising” and “wherein,” respectively. Moreover, the terms “first,” “second,” and “third,” etc. are used merely as labels, and are not intended to impose numerical requirements on their objects.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. An apparatus, comprising:
a power transmitting unit (PTU); and
logic, at least a portion of which is in hardware, the logic to initiate an extraneous object detection procedure to check for a presence of extraneous objects within a transfer field of the PTU during operation of the PTU in a power transfer state, and in response to a detection of an extraneous object, send an extraneous object notification message to a power receiving unit (PRU) and determine whether to maintain the PTU in the power transfer state based on a determination of whether the extraneous object comprises a rogue object.

2. The apparatus of claim 1, the logic to send the extraneous object notification message to the PRU via an in-band signaling mechanism.

3. The apparatus of claim 2, the in-band signaling mechanism comprising modulation of a power transmission of the PTU.

4. The apparatus of claim 1, the logic to send the extraneous object notification message to the PRU via an out-of-band signaling mechanism.

5. The apparatus of claim 4, the out-of-band signaling mechanism to comprise wireless communication via a Bluetooth Low Energy network.

6. The apparatus of claim 1, the logic to transition the PTU into a non-power-transfer state in response to a determination that the extraneous object comprises a rogue object.

7. The apparatus of claim 6, the non-power-transfer state to comprise a latching fault state.

8. The apparatus of claim 6, the logic to enforce a programmable delay prior to transitioning the PTU into the non-power-transfer state.

9. The apparatus of claim 1, the logic to maintain the PTU in the power transfer state in response to a determination that the extraneous object does not comprise a rogue object.

10. A wirelessly-chargeable device, comprising:
a power receiving unit (PRU) to receive power from a power transmitting unit (PTU); and
logic, at least a portion of which is in hardware, the logic to receive an extraneous object notification message indicating a presence of an extraneous object within a transfer field of the PTU and in response to receipt of the extraneous object notification message, initiate a user alert procedure to cause presentation of an extraneous object alert.

11. The wirelessly-chargeable device of claim 10, the user alert procedure to comprise presenting the extraneous object alert at the wirelessly-chargeable device.

12. The wirelessly-chargeable device of claim 10, the user alert procedure to comprise sending an alert forwarding message to cause presentation of the extraneous object alert at a remote mobile device.

13. The wirelessly-chargeable device of claim 10, the logic to receive the extraneous object notification message from the remote device via an out-of-band signaling mechanism.

14. The wirelessly-chargeable device of claim 13, the out-of-band signaling mechanism to comprise wireless communication via a Bluetooth Low Energy network.

15. The wirelessly-chargeable device of claim 10, comprising:
at least one processor; and
at least one memory.

16. The wirelessly-chargeable device of claim 15, comprising:
at least one radio frequency (RF) transceiver; and
at least one RF antenna.

17. At least one non-transitory computer-readable storage medium comprising a set of instructions that, in response to being executed at a wireless power transfer device, cause the wireless power transfer device to:
initiate an extraneous object detection procedure to check for a presence of extraneous objects within a transfer field of a power transmitting unit (PTU) of the wireless power transfer device during operation of the PTU in a power transfer state; and
in response to a detection of an extraneous object:
send an extraneous object notification message to a power receiving unit (PRU); and
determine whether to maintain the PTU in the power transfer state based on a determination of whether the extraneous object comprises a rogue object.

18. The at least one non-transitory computer-readable storage medium of claim 17, comprising instructions that, in response to being executed at the wireless power transfer device, cause the wireless power transfer device to send the extraneous object notification message to the PRU via an in-band signaling mechanism.

19. The at least one non-transitory computer-readable storage medium of claim 18, the in-band signaling mechanism comprising modulation of a power transmission of the PTU.

20. The at least one non-transitory computer-readable storage medium of claim 17, comprising instructions that, in response to being executed at the wireless power transfer device, cause the wireless power transfer device to send the extraneous object notification message to the PRU via an out-of-band signaling mechanism.

21. The at least one non-transitory computer-readable storage medium of claim 20, the out-of-band signaling mechanism to comprise wireless communication via a Bluetooth Low Energy network.

22. The at least one non-transitory computer-readable storage medium of claim 17, comprising instructions that, in response to being executed at the wireless power transfer device, cause the wireless power transfer device to transition the PTU into a non-transfer state in response to a determination that the extraneous object comprises a rogue object.

23. The at least one non-transitory computer-readable storage medium of claim 22, the non-transfer state to comprise a latching fault state.

24. The at least one non-transitory computer-readable storage medium of claim 22, comprising instructions that, in response to being executed at the wireless power transfer device, cause the wireless power transfer device to enforce a programmable delay prior to transitioning the PTU into the non-power-transfer state.

25. The at least one non-transitory computer-readable storage medium of claim 17, comprising instructions that, in response to being executed at the wireless power transfer device, cause the wireless power transfer device to maintain the PTU in the power transfer state in response to a determination that the extraneous object does not comprise a rogue object.
